(19) United States
(12) Patent Application Publication
(10) Pub. No.: US 2009/0216668 A1
(43) Pub. Date: Aug. 27, 2009

(54) METHOD OF CARRYING OUT A BUSINESS VENTURE

(76) Inventor: James William WEDDERBURN, Moncton (CA)

Correspondence Address: James William Wedderburn, P.O. Box 23014, Moncton, NB, E1A 6S8, CA

(21) Appl. No.: 12/392,749

(22) Filed: Feb. 25, 2009

Related U.S. Application Data
(60) Provisional application No. 61/031,338, filed on Feb. 25, 2008.

(51) Int. Cl. G06Q 40/00; G06Q 10/00

(52) U.S. Cl. 705/30; 705/37; 705/36 R; 705/35

(57) ABSTRACT

This invention deals with corporations involved in new ventures, providing novel means and methods to increase the likelihood of their success. It also provides an exchanges on which corporations of these types can trade shares. The corporations use a preferred share structure which incorporates fiscal financial projections, so that there is ensured both a reasonably calculated percentage of revenues on sales issuable to the shareholder while still protecting the corporation and the venture with a threshold of revenues on sale that must first be realized before the dividend is issued. The means and methods of the claimed invention mitigate or erase the occurrence many of the usual obstacles which present themselves to derail ventures.

This application claims the benefit of the filed U.S. Provisional Patent Application No. 61/031,338, entitled A Method of Carrying Out a Business Venture, which is here by incorporated by reference.

### FIELD OF THE INVENTION

The present invention relates to starting up and carrying out a new venture, and more particularly to starting up and carrying out a new venture where a specific share structure is created.

This invention provides for the creation, growth and running of a privately-held company involved in a new venture. The problems facing a privately-held company starting a new venture are quite different from those facing an established company with a track record or already having the means to take its product or service to market.

The invention also provides a means to ensure that a company will operates within safe parameters, where neither the originator, nor the investor, nor the company can overpower the other to the detriment of all involved. This invention results in there being a vendible product to the investor, ie the shares of the company, with as much meaning as does the vendible product or service to the market. A balance is created so that a venture can operate with reduced risk of failure.

### BACKGROUND OF THE INVENTION

A major cause of business failure for any venture is that there is an imbalance between the parties. Each of the parties, in trying to get the most for him/herself and having more power than the other parties, can end up taking more than can be sustained for the survival of the company, and consequently there is failure. This invention restricts the direction that any of the parties can assert onto the other by controlling critical activity, that if not controlled, could derail the venture.

Success of any venture depends, at least to some extent, on there being a good relationship between the four interacting parties, namely the originator, the investor, the corporation and the market. This relationship is easier to achieve if, as between the different parties, there is transparency, control and fairness.

By transparency, it is meant that it would be preferable if the relationship between the four parties is known and accepted, and predictable. Upon being achieved, it would mean that no further energy would be required to establish what is not known, or what has to worked out. Despite there being little argument as to the importance of transparency, it is more often the case that parties, especially as between the investor and the originator, try to be clandestine in their interacting with each other. With each party out for him/herself, as circumstances evolve, it is quite often the case each party is trying to re-arrange the relationship to take more for themselves. As well, where there is no transparency, it wastes valuable energy of the participants in arguing, or negotiating. To date, achieving transparency remains a problem with most companies engaging in new ventures and is an obstacle to the venture being a success.

By control, it is meant that there has not usually been to date a means to establish meaningful parameters so that each party is best able to use its strength optimally for the purposes of the venture, but not destructively. If there were such parameters, no party would be able to interfere with the domain of the other. Too often, presently, when the issues of control are not resolved, or are open to change, with each party trying to get as much control for itself at the expense of the other, shifts in power and direction often occur not in the best interest of the over-all success of the venture. One party may even be ousted from participating, suppressing expertise needed by the company. To date, achieving a balancing of control remains a problem with most companies engaging in new ventures and an imbalance of control is an obstacle to the venture being a success.

By fairness, it is meant that it is difficult to structure a company where each party will receive a fair return for its input and, as well, have any assurance of what that return will be upon entering into the venture. There is often, until the return actually occurs, too much gamble and not enough certainty. Presently, especially with private companies starting new ventures, with there being no express parameters within which to gage what return a party will be receiving, the parties use all of their strength possible to push for their own interests as against those of the other parties. Because of the inherent unequal strengths, any conflict or struggle can result in one party being so overwhelmed by the power asserted by another party that it is pushed out of the corporation or prevented from receiving its fair share of return. To date, achieving fairness remains a problem with most companies engaging in new ventures, and unfairness is an obstacle to the venture being a success.

Given that the different parties are intrinsically self-serving and wanting the best for themselves, and that these attitudes cannot be changed, these resulting obstacles have for the most part come to be accepted as the norm. There is absent presently a means where the different interests can interact with a greater degree of compatibility, despite this self-serving tendency being accepted, without the danger of causing the corporation to falter.

The acceptance of these obstacles in some part is balanced by the fact that this principle of self-interest of each of the parties has a necessary and good side as well. There is, after all no doubt, that the success of a venture does to a large extent depend on the passionate drive of the participants. Nevertheless, there exists the irony in new ventures that the same strengths, which need to be maximized, can also cause an imbalance. There is presently no means which, while still permitting those necessary driving passions to assert themselves, establish a meeting ground, or a forum of participation, for the four parties (ie the originator, the investor, the corporation and the market) to come together to work toward a common goal of building the venture in a manner, which utilizes the participants' best strengths and encourages their optimal contribution.

Presently, the power of each of the participants remains unchecked except by their own discretion.

As the above is generally known, it is also known and generally agreed that if those obstacles can at all be prevented, or the possibility of their occurring reduced, many more ventures would be successful than presently is the case.

The effect of the obstacles, namely unfairness, improper control and a lack of transparency can play out in predictably bad ways for business ventures. The symptoms appear as bad product-market planning; inadequate financing; poisoned relationships between the parties and inadequate administrative (accounting and legal) support.

In a venture, it should be, but is often not, understood that the failure occurs, not even because of what the product or service is. For the reasons set out above, even if the very best and most useful product or service is created by the venture, if there is an imbalance in respect of control, transparency or fairness in any of those factors, the venture can fail. Yet, at the conception of the business and for most of the initial planning and running of the venture, the originator usually only considers the merit of the product or service. Many new ventures fail because, after the product or service has been developed, an imbalance created by either their obstacles or their symptoms.

Moreover, usually these issues are not dealt with until they become a problem, ie until the symptom surfaces. There is no prevention; there is generally no anticipation. It is almost trite to say that ventures are generally run as not bothering to deal with problems until they become a problem or requirement, and even then, not dealing with them squarely, until they become a serious problem or requirement. Apart from this being an undue emotional, and sometimes physical, drain on the originator, dealing with them can cause a shift in the relationship between the originator, the investor, the company, and the market, to totally derail any proper balance and potentially sink the company.

When dealt with on the fly, with no anticipation, and no infrastructure in place to prevent or absorb the occurrence, there is often an urgency required. This urgency to act affects the quality of response, meaning that only those solutions available at the time of the crisis are considered, and this is done at a time when the decision-maker is frantically grasping for a quick resolution, the degree of perfection or the side effects taking a second seat to getting the problem out of the way. So it is that, as each party is being driven by its need to take as much as it can for itself, there is often an upsetting of the transparency, the fairness and the control. In other words, there is an upsetting of the balance that results.

But as there is a high probability that a problem within the above-described context will occur, it can almost be taken as a given that all new ventures would benefit if these problems in these areas were either eliminated, or the probability of their occurrence greatly reduced, by providing a means where there is a build-in balancing force affecting the transparency, control and fairness as between the four parties. The consequences otherwise is that if a miscalculation or a mistake is made at the wrong time in dealing with the problem that does arise, recovery can become impossible or the company may be set up for a worse catastrophe, or pay dearly for having taken the less than optimal solution with whatever imbalance results.

Predictability aside of the imbalances in transparency, control and fairness, and the symptomatic problems that result in the different areas, there has been no conceptually holistic means invented, prior to this invention, which could be adopted at the beginning of the life of the venture so that the possibility of the occurrence of any of these obstacles or resulting problems in any area would be minimized or eliminated. The elimination of these obstacles, by creating a balance that is stable at the beginning of the venture, would provide for a clear path to success in the matter of so many new ventures that are otherwise sound in their operation, direction and product or service.

Moreover, if such a holistic process could be created for a single company, there would be collateral benefits application to using it for several companies to multiply its effect. It would not only change the way that business is done on the micro scale, but also how it is conducted on the macro scale, creating a new standard of stability for companies across the board.

Considering the situation on the macro scale as it now exists, the standard of operation between different companies as it presently exists is quite varied because there are no accepted parameters of balance between the investor, originator, company and market, within which the parties agree to operate. Each venture is the result of a tug and push power struggle between the participants with the victor sometime taking so much that the complete venture is destroyed, be it through bad revenue distribution, improper administration, management interference, or market miscalculation. There is presently such a variance between different companies, that if an investor is having to make a choice, such as would be the case in choosing an investment on an exchange or in choosing direct investment opportunities, the investor must presently evaluate separately each company into which s/he is considering investment and cannot often rely on similar information as it exists for two companies as having a similar meaning. Nothing can be taken as a given.

For instance, presently, when an investor is looking as between two different companies competing for his or her investment monies, the investor should review at a minimum management, financial statements, financial projections, projected return, share structure to evaluate the transparency, the fairness and the control of the company. In each case, it will not only be quite different, but the standards of measurement different. So much will have to rely on the discretion or indiscretion of the players and the tendency to change that balance for the betterment of one party over another in the case of an upheaval. Due diligence is difficult.

Therefore, if such an invention could be invented for a single company, the same invention could be embodied to even greater effect for a group of companies. With an exchange for a group of companies so that each of the companies within that group could be compared with relative assuredness as regards to the main risk factors. Such an invention would permit easier trading amongst investors because more information would be known about the value of the company using a more objective, as opposed the now separately subjective, standard of comparison. Presently, no such forum exists where investors can see and trade within a congregation of similarly run companies although such a forum would provide greater assurances for the investors.

Regarding an exchange for new businesses, such an exchange would also address other common difficulties that originators have, namely accessing investors and suitably explaining the business model that is being used. This presently is compounded further if a middle man is used for raising money because it tends to add on only another layer of people to whom the model has to be explained. The more layers that are added on, the more difficult it only takes one person in the chain of communication for there to be a misunderstanding for everyone. It also solves a problem so often articulated by the investor, namely a concern about there being a means or way to sell or trade his shares as the value changes, or merely to have an avenue of escape from the investment. Taking the embodiment of this invention to the exchange level therefore has value and would be an advance in the art.

It is an object of the present invention to provide an invention so that the conduct of any of the main four participants (originator, investor, company, and market) is refrained from contributing to the mishandling of many of the common problems that start-up ventures face, and are guided to deal with each other in a manner to that end, the main problems having to do with the possibility of the ventures failing due to product-market miscalculation; imprudent financing; off-kilter originator-investor-market relationships and interactions; improper task delegation; and inadequate administrative (accounting and legal) support.

It is another object of the present invention to provide for a company an infrastructure that provides for both a decent return to the investor and, as well, that provides the originator with the means to maintain control and ownership of the business while himself receiving fair remuneration.

It is another object of the present invention to provide an invention for a business that permits the starting up and the efficacious running of the venture with guidelines and parameters enforcing fairness as between the originator, the investor, the market and the company. Whoever works for the company, whoever invests in the company and whoever runs the company can only work within those parameters. That being so, with these parameters preventing many of the major mistakes known and acknowledged to be detrimental to the starting of a venture, the company and business are better able to flourish.

It is another object of this invention to provide a process that when adopted by a company will give assurances, to the investor, of a standard of transparency, fairness and control balance that results from the application of the process.

It is another object of this invention to provide an invention that when adopted by a group of companies, this group of companies will have shares which can be relatively valued and traded as between the shareholders of the different companies within the group.

It is another object of this invention to provide a method of doing business, which can be adopted by companies within a trading exchange, so that these companies can be recognized by investors and valued accordingly.

It is another object of the present invention to create an exchange which includes companies formed and operating in accordance with this invention that would permit the shareholders of the various companies to trade amongst themselves.

It is another object of the present invention to create a quality control overseer organization to which companies adopting this invention can belong so to use a confirmation of membership to this overseer organization as an indicator to investors and potential investors that this invention is being utilized by a company.

It is another object of the present invention to provide an exchange which includes companies formed and operating in accordance with this invention to facilitate access of the originator and company to the investor, and to provide a means whereby the business model is explained to the investor in a standardized and safe manner.

### SUMMARY OF THE INVENTION

According to an aspect of the present invention, there is provided: a method for the carrying out of a venture comprising the steps of: a) the creation of a share structure, which defines common shares, and preferred shares, wherein the preferred shares have a preferred dividend issuable to the owners of preferred shares in a manner consistent with the attaining of a stage where revenues on sales in the venture are sufficient to render the further sale of preferred shares not pertinent to the financing of the venture, the stage being a non-pertinent stage, the issuance of the preferred dividend being defined as having a condition of discontinuance; b) the preferred shares only providing for the issuance of a preferred dividend upon achieving a defined threshold of revenue on sales for the venture by the corporation; and c) the creation of financial projections predicting the occurrence of the non-pertinent stage.

According to another aspect of the present invention, there is provided: a method of doing business wherein a corporation is organized under articles of incorporation wherein: a) the articles of incorporation shall define a share structure comprising common shares, and preferred shares, wherein the preferred shares have a preferred dividend issuable only to the owners of preferred shares in a manner that will not prevent the attaining of a stage where revenues on sales in the venture are sufficient to render the further sale of preferred shares not pertinent to the financing of the venture, this stage being a non-pertinent stage, the issuance of the preferred dividend being defined as having a condition of discontinuance; b) the articles of incorporation define the preferred shares as not providing for the issuance of any preferred dividend until after a minimum threshold of revenue on sales for the venture has been received by the corporation.

According to another aspect of the present invention, there is provided: a method for organizing a corporation involved in a new venture, the steps of: a) preparing articles of incorporation in accordance with financial projections identifying the stage wherein the sale of preferred shares become non-pertinent to financing the venture wherein the articles of incorporation are drafted: I) to define the share structure to provide for the issuance of both common shares and preferred shares, wherein the preferred shares have a preferred dividend issuable to the owners of preferred shares only after a minimum threshold of revenue on sales for the venture has been received by the corporation; and ii) to define the issuance of the preferred dividend as having a condition of discontinuance.

According to another aspect of the present invention, there is provided a method for the carrying out of a business venture to provide goods or services to a market comprising the steps of: a) preparing fiscal financial projections for the venture wherein the corporation for the venture shall have preferred shares apart from common shares to permit the corporation to finance the venture; b) preparing the fiscal financial projections to predict the stage where revenues on sales in the venture are sufficient to render the further sale of preferred shares not pertinent to the financing of the venture; c) preparing the fiscal financial projections in contemplation that preferred dividends for the preferred shares shall have a condition of discontinuance; d) preparing the fiscal financial projections in contemplation that the preferred shares shall not provide for the issuance of any preferred dividend until after a defined threshold of revenue on sales has been received by the corporation for the venture; e) preparing of the financial projections to provide a threshold of revenue on sales to be inserted into the articles of incorporation to define the conditions for issuance of the preferred dividend.

According to another aspect of the present invention, there is provided: a method of doing business, wherein services of a forum for trading shares of privately-held corporations are provided, comprising the steps of: operating an exchange, the exchange forum comprising several privately-held corporations each having common shares and preferred shares, the preferred shares having a preferred dividend wherein the privately-held corporations can issue preferred shares with preferred dividends, the preferred dividends being based on a pre-defined portion of the revenues on sales for a venture, the preferred dividends being defined as being issuable after a pre-defined threshold of revenues on sales for the venture has been achieved and also being defined as having a condition of discontinuance; the exchange being operated to permit the preferred shares to be traded, bought and sold amongst different owners of shares of member corporations on the exchange.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the A Method of Carrying Out A Business Venture according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. The invention will be readily understood upon reference to the drawings describing the preferred embodiments, in combination the explanation provided below. In the accompanying drawings:

FIG. 1 is a schematic block illustration illustrating generally the main components of the preferred embodiment of this invention and how the different parties interact;

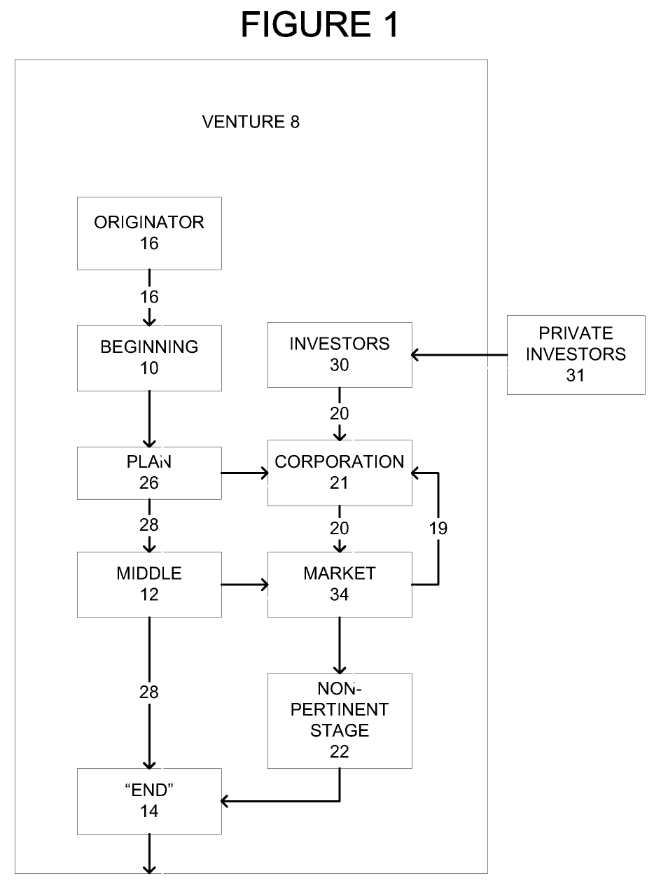

FIG. 2 is a schematic block illustration the relationship of different parties and how the invention permits them to interact with the infrastructure of a corporation; and,

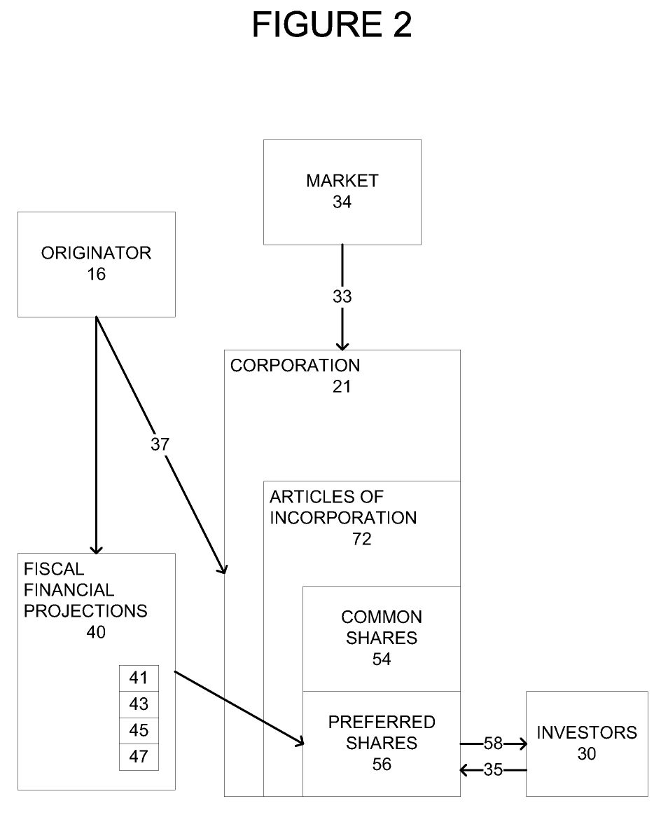

FIG. 3 is a schematic block illustration illustrating an exchange in accordance with this invention.

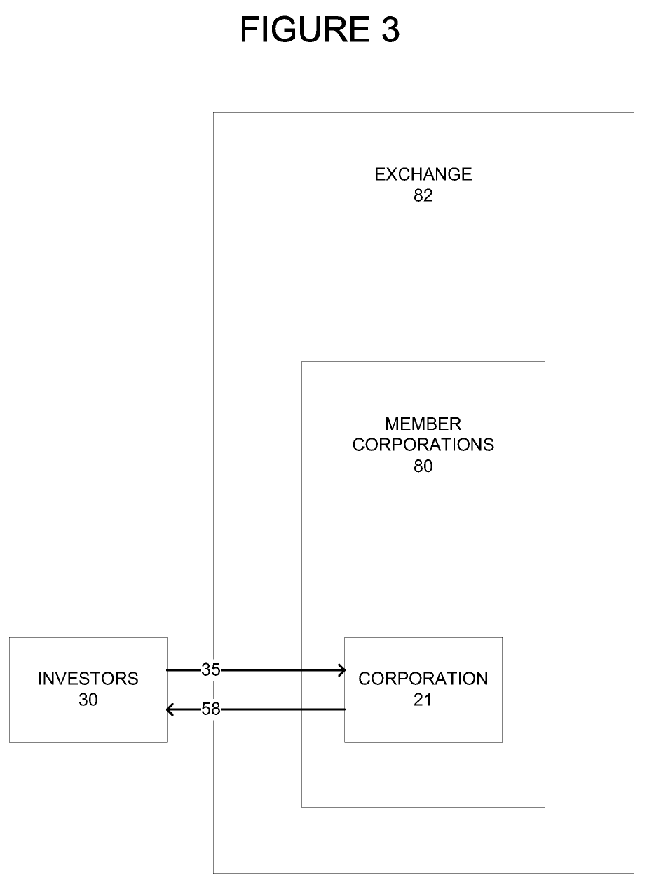

### DETAILED DESCRIPTION OF A PREFERRED EMBODIMENT

Referring to the drawings, the invention settles around the carrying out of a venture 8.

The venture 8 has a beginning 10, a middle 12 and an “end” 14. In respect of the invention, the beginning 10 is the originator 16 and the idea 18; the “end” 14 is when the venture 8 is at market 16 and the revenues on sales 19 versus expenses 20 relationship is lop-sided enough in favour of revenues on sales 19 such that it is no longer pertinent whether investor money 20 comes into the corporation 21 to sustain its operations (the non-pertinent stage 22); and the middle 12 is everything inbetween. Of course, the venture continues on after the “end” 14. After the “end” 14 is when everyone starts to realize the return on their efforts. However, it is the “end” 14 for the purposes of the description of this invention, because it is the “end” 14 of the most serious and difficult period, the start-up period, when the obstacles are the most difficult for the venture to overcome.

Before anything happens, there stands alone the originator 16 who contemplates a venture 8. Broadly, speaking a venture is the providing of a service or product 24 which can be sold to generate revenues on sales 19.

To carry out the venture 8, a corporation 21 must be formed, and the inventors have found through their invention that this act, at a time as singular and simple as the beginning, namely how the corporation 21 is, formed can to a large extent be used to reduce or eradicate the probability of the major obstacles preventing the success of the venture 8. Those obstacles are, conceptually, obtaining balances in regards to fairness, transparency and control, so to prevent a manifestation of the symptoms, namely bad product-market planning; insufficient financing; poisoned entrepreneur-investor-market relationship; inadequate administrative (accounting and legal) support.

However, simple and holistic the “how” that the embodiments of this invention provide, to understand the invention, some appreciation of the rather complicated interactive events that occur in the middle 12 need be understood, at least conceptually for the venture.

In respect of ventures to which this invention applies, and these ventures are new ventures for privately-held companies, ie the type of ventures for which it is the most difficult to get working, it is realized at least by most originators that s/he must generally that, after the idea, there must follow a plan 26 and an execution of the plan 28, within which to draw investment 20 from investors 30 to get through the middle 12 of the venture 8 so that the product or service 24 exists and is being sold and revenue on sales 19 are being generated. As previously discussed in the application, however, most originators 16 find out that the middle 12 is the most difficult and the most determinative portion of the equation.

The first practical problem for the originator 16 is the obtaining of enough financing. Unless the originator 16 is self-financing, investment 20 has to come from in from other sources. But for new ventures, the sources are limited usually to private investors 30, and, even more difficult, the private investors 31 have to be sought individually because the venture is a private entity. By private entity, it is meant a person who is not listed on a public securities exchange available for review and investment by, generally, members of the public where the onus is more on the public ensure that due diligence has been conducted or the necessary information sought before investment. Such public securities exchanges, outside the scope of this invention, would include stock market exchanges such as the New York Stock Exchange (NYSE), Tokyo Stock Exchange, London Stock Exchange and Toronto Stock Exchange (TSE), which list public companies well established compared to the situation in which the originator 16, as meant in the context of this specification, exists. Public entities have a multitude of sources of financing such as private individuals who go to the stock exchange to park their investments, government loans or subsidies, institutions with investment money, or even private banks.

So it is that the originator 16 to which this invention pertains, and most probably a person or persons without any record of previous success in business, basically only has one source into which to tap initially for financing, and that source is the private investor.

The vendible product or service for the market therefore is no longer the only selling that the originator must consider. S/he must also consider the vendible product that must be sold to the investor, namely the share or interest in the company.

To create the share into a concrete vendible product rather than an abstract one, it is for that reason that a corporation 21 must be formed. From the originator's viewpoint, the corporation 21 provides a link 33 therefore not only to the market 34, but a link 35 to the investor 30. However, from a more objective viewpoint, for instance from the viewpoint of the investor 30 and the market 34, the corporation 31 provides a link 37 to the originator 16. So far, everything described is known to the art.

As a first aspect of the present invention, it is the “how” that the corporation is formed that provides a differentiation with the prior art so that a fair, transparent and balanced relationship between the corporation 21, the originator 16, the investor 30 and the market 34 is created.

The idea 18 and the originator 16 already existing, if the corporation 21 still needs, however, more conventional information to achieve the “how”. It is not usual practice, but it is conventionally agreed that the production of fiscal financial projections 40, objectively produced and recognizing the costs 41, time 43, production realities 45 and market realities 47, (basically incorporating the information that is essential to a complete business plan) are a good idea. In respect of the present invention, they are a necessary precedent to the “how” because they create the first transparency that all parties should be able to rely upon to base their participation.

These fiscal financial projections 40 are not new, even if they are not conventional, and there are standard procedures used by qualified professionals for their generation. Applying these conventions conventionally, the fiscal financial projections can be of great value, but, as they are of themselves part of the prior art, no invention is claimed in respect of the financial projections per se apart from the invention as a whole.

The generation of these fiscal financial projections 40, no matter from whom they are generated, can be a significant cost and require great effort, but they are valuable in bringing together so many divergent factors to best predict the course of the venture. At a minimum, they would consider what the product or service is, what the costs of running the corporation will be, where and how the product or service is going to be sold, and what revenues on sales versus expenses are likely going to be over time. In short, the financial projections should be the first indicator of when and if the venture 8 will become profitable.

As this is a starting point in determining whether the venture 8 is worth pursuing. So many projects would not and should not proceed, and yet it is not known at the time of commencement because something so important, and relatively cost effective (even if the cost is significant) as fiscal financial projections 40 have not been completed (and they rarely are) to the stage where there is some articulated understanding of where the market 34 is, how the product or service 24 is going to be made or produced, and where it is going to be sold, and what milestones the originator is looking to accomplish.

It is also preferable that the fiscal financial projections signed off on and even prepared by an accounting professional licensed by jurisdiction, who is arms-length to the originator 16 so that the most objective standard is used. This, of course, ensures that there has is some objective basis behind them.

Importantly, what these fiscal financial projections 40 accomplish is that they provide a hard consideration of what can and should happen, including product-market planning; financing needs; entrepreneur-investor-company-market relationship; administrative (accounting and legal) support needs and costs, and, as well, a prediction regarding revenues, sales or otherwise, and, related to all of that, what the needs for investment are.

As all of this information comes together in the fiscal financial projections and by only looking at the fiscal financial projections all of this information (ie any information that the fiscal financial projections reflect) can be incorporated into any further step taken in the middle 12 of the venture 8.

And it is here that exists, one of the points of invention, namely the inventive step of a novel manner of structuring the shares 52 of the corporation, ie the vendible product for the investor, in combination with qualifying the magnitude of that structuring in a manner that sets the venture on a course where there is I) both a balance in fairness, transparency between the different players; and ii) the shares 52 accord with what has been shown and determined by the fiscal financial projections 30.

It will be known and generally agreed that if, at this stage, there is no likelihood of revenues on sales becoming enough to obtain a reasonable return given the financial investment required, the venture dies at this point. However, should the financial projections show that the corporation will be able to realize revenues on sales large enough to yield a reasonable return to both the originator and the investors, then the venture can proceed to having the corporation formed in accordance with the fiscal financial projections.

Forming the share structure of the corporation in accordance with the fiscal financial projections is therefore a key aspect because it defines the parameters within which the investor and the originator shall deal with each other, and what return the investor shall receive. Doing so sets the correct course during the middle phase 12.

Although this principle is easy to articulate, it has not at all proven obvious how to execute prior to this invention, even using these principles as a guide.

The usual manner of forming a corporation, whether there have been or not been fiscal financial projections 40 produced, has been to create both common shares 54 and preferred shares 56 within the articles of incorporation 72. (By articles of incorporation 72, it is meant whatever legal documents are required to create and organize the company so that it has the status of a legal person.) The preferred shares 56 have some aspect in their characteristic that gives the owners of their shares (ie an investor 30) a preference over the owners of common shares (which would include the originator 16). The possibilities and different types of preference are numerous. So it is, that by using the term preferred share 56 in this specification, it is meant a share that provides its owner a preferred right over the owner of a common share and it is as such that it is generally known and accepted by those in the art.

In the past and present, it has often been and is common practice to create both common shares 54 and preferred shares 56 wherein the preferred shares 56 have a preferred dividend 58. The preferred dividend 58 is paid only to the owner of the preferred share 56 (ie some of whom are investors 30) and not received by the owners of common shares (ie some of whom are originators 16). The dividend payment may be ongoing without discontinuance or it may end at a particular time. The problem in the past and often presently with preferred dividend issuance (ie payments) 60 on preferred shares 56 is that, even if they are based on a portion of revenues on sales 19, which is rare, there has been no simple mechanism, both built into the structure of the preferred shares 56 and tied into the fiscal financial projections 40, which would protect the corporation 21 by providing a safe start date, a safe check system once payments start, so that the corporation 32 is protected and able to meet its other expense obligations. Problems could easily occur in this regard if the fiscal financial projections are not met. An overly-tight definition can be a problem therefore because it can define a commitment that cannot be met. However, on the other hand, if the degree of payment of the preferred dividend is not defined tightly enough in the organizing document, which is presently more the usual practice than not, it reduces the certainty and the transparency of the value of the preferred shares 56. In the second scenario, one looks at the definition of the preferred dividend issuance and one cannot tell the value of the shares from the definition because the value is not dependent on what has been written but rather the discretion of whomever is controlling the corporation 21. As such, not providing a sufficient degree of definition in the organizing document can provide for a battleground of dispute between the investor and the originator for control. The battle may occur when the negotiation of the terms of sale of the preferred shares is being entered into or down the road if the corporation 21 runs into difficulty and is in need for more investment. In this second scenario, as it is usually is the case that the originator 16 is the weaker party at a stage of financial desperation, huge concessions are often provided to the purchaser of the shares that can cripple the corporation 21 and make it vulnerable to take-over, either to the investor or to others.

Of the above, neither scenario is desired. In the case where the definition is too tight, an imbalance is created if there is a deviation from fairness if fiscal financial projections are not met. In the case where the definition is not tight enough, there is no transparency and it causes issues regarding control. As it usually comes to an issue of what is easier at the time of drafting and creating the shares, the most often taken approach in the past and present, however, is that the originator 16 does not tightly enough define the preferred shares 56 and it leads to control issues. But neither scenario is desired.

It would be better that the preferred dividend 58 in some way be defined with enough certainty to that it is both transparent and reassuring to the investor 30, but, balancing that, also that it is reassuring to the corporation 21 and to the originator 16 that it would include a safety mechanism so that the instance of payments on the preferred share 56 cannot be made to the extent that they damage the corporation. As well, there should be some innovative mechanism in the share structure that prevents the issuance of the preferred dividend 58 from commencing before the corporation is receiving enough revenues on sales 19 for the venture 8 to cover the expenses of the venture.

Looking at fiscal financial projections 40, properly prepared as described above, it is determinable not only when the corporation's revenues on sales 19 will become greater than expenses 21, but as to the extent of their differences. This extend of differences in turn easily provides a reasonable date, readily apparent, and as of that date, a defined threshold of revenue on sales 19 that must be attained for the venture such that further investment is not required from the selling of preferred shares to investors to further finance the corporation for the venture 8. (There may be other reasons or requirements outside of the particular venture for the continued raising of investment through the sale of shares, but in respect of the venture those sales would be non-pertinent.)

So it is that the creator of the structure of the preferred shares is able to determine with some reasonableness from the fiscal financial projections a threshold of revenue on sales required in any fiscal year before preferred dividends should become either calculable or payable. This value or, to be sagaciously cautious, a higher value is used to define the payment of the preferred dividends 58 so that the issuances of the preferred dividends can be not only based on a portion of the revenues on sales for the venture, but not adversely affect the financing of the venture 8 if the fiscal financial projections are deviated from.

The share structure is therefore defined in accordance with the fiscal financial projections 40 so that the issuance of preferred dividends 58 is made at a non-pertinent stage 62, the non-pertinent stage being a stage in the life of the venture when the financing of the venture would not be adversely affected by preferred dividend issuance. It is done by including within the definition in the articles of incorporation 72 a threshold of revenues on sales for the venture that must be met before issuance of preferred dividends can be made. It is a simple drafting insertion, a deep thought and consideration, but is all of transparent, fair to create boundaries that can prevent disputes over control.

As well, to the above, however, there must be certainty of when the obligation of issuance will end in respect to the preferred dividend. A condition of discontinuance such as a time period, or preferably when the issuance of preferred dividends accumulate to a total, at which time the preferred share either becomes emasculated of any benefit or it converts to a common share or the corporation buys it back at a predetermined amount or something else, as determined at the planning stage happens. This is necessary for there to be a greater certainty in the value of the corporation after the “end” 14 has been reached, it being generally considered that if there exists an open liability such as a preferred dividend based on a portion of revenues on sales in any form that continues forever, it adversely affects the value of the corporation 32 as a whole and, in the long run, prevents the corporation 21 from being able to control its future development and the re-investment of retained earnings.

The inventor has found that it works well in practice that the share be made, upon payment of an accumulated total over a period of time, that the corporation automatically convert the preferred share to a common share. The term of discontinuance will be an issue of the circumstances and of the preference of the originator, but it must exist.

So it is that there is disclosed a method for the carrying out of a venture 8 which is manifested in the creation of a share structure having both common shares, and preferred shares. The preferred shares, as do most preferred shares, are defined to have a preferred dividend issuable to the owners of preferred shares. However, to make the corporation wholistic, using the shares as a means to tie in the characteristics of the venture, protect all of the interests of the investor, the originator and the company with certainty and carefully considered fairness, the preferred shares are provided with a dividend that takes from a portion of revenues on sales. The portion is as generous as possible, but is prevented from causing damage to the corporation because there is a threshold of revenue on sales for the venture that must be attained before issuance of the dividend is possible. For instance, before the preferred dividend can be issued, depending on what would be consistent with the fiscal financial projections, the amount of $2 million might be required as a threshold in any given fiscal year before any preferred dividend becomes issuable or owing. The threshold, by incorporating a consideration of the fiscal financial projections, can be set at a level to ensure that neither the financing of the venture nor the health of the company will be adversely affected. It will be readily apparent to a person of ordinary skill in the art looking at the fiscal financial projections at what point of revenue growth, given that the fiscal financial projections take into account both the expenses and revenues, when the revenues on sales surpass a threshold necessary to issue a sufficiently high dividend to a preferred shareholder, who is the investor. That threshold, or one above it to provide a cushion, is inserted into the articles, again for certainty and transparency, to that the venture is protected and made strong from the share structure. In any case, it can be said that, by using this share structure, the issuance of a preferred dividend will be of an easily calculable portion, relatively predictable in amount and timing by reason of the fiscal financial projections, and that the payment is designed, by the method of defining and structure of the share, only occurs at a stage where revenues on sales in the venture are sufficient to render the further sale of preferred shares not pertinent to the financing of the venture. Again, as it can be readily calculated by a potential investor from the fiscal financial projections what the rate of return will be, whether the fiscal financial projections appear to be reasonably calculated, the investor can make a better informed decision of whether the return is sufficient as regards the risk. If the return is not sufficient for the amount of investment relative to the risk for any potential investor, again, as was the case where it was shown before in the case where the fiscal financial projections showed that no return was possible, the venture will die before undue effort and money is needlessly expended.

As an example of the above, and used by the inventor successfully, preferred shares were created having both common shares and preferred shares, with the preferred share having a preferred dividend incorporating the fiscal financial projections prepared for the venture. The preferred dividend was defined to be collected as a percentage of revenues on sales collected above a threshold. Specifically, it was 15 percent of revenues on sales received after the threshold of 5 million dollars on revenues for sales in any fiscal year had been reached. The portion of 15 percent of revenues on sales owing was collected and deposited into a fund to be issued to the shareholder within 30 days of the end of the of the fiscal year relating to the revenues on sales from which it was taken. As well, when the accumulated preferred dividends paid in respect of any preferred share reached the amount of $10 for the preferred share, it automatically converted in to a common share. The value of the share, and the amount which the originator was able to sell the share increased over the life of the venture while the product was developed, and as the milestones in the fiscal financial projections were met.

Although there is a lot of factors which must be brought together, not so obvious to those undertaking ventures, there is, as an aspect of the present invention, a simple novel manifestation of the invention existing in the plain share structure, and, as it is in a plain share structure, it also exists in the articles of incorporation. Upon reviewing the public document, which has acts both as a contract and as a definer of parameters, the characteristics of fairness and transparency are effected, and several issues of dispute relating to control are removed.

A review of the articles drafted in accordance with this invention can also be easily indicative to a potential investor, or any member of the public, that the invention may comply with this invention and therefore has the beneficial qualities. If the articles of incorporation 70 define preferred shares 56 with preferred dividends 58, and common shares 54 without the preferred dividends 58, wherein the preferred dividends are defined to be in accordance with the fiscal financial projections by being issuable in a manner that will not prevent the attaining of a stage where revenues on sales in the venture are sufficient to render the further sale of preferred shares not pertinent to the financing of the venture. The mechanism of a readily identifiable minimum threshold of revenue on sales being required before issuance of the preferred dividend ensures that issuances are not being made at the expense of capital, and as the threshold accords with the fiscal financial projections, there is a mechanism to discern its reasonableness. A balanced playing field exists between the parties.

The articles of incorporation 72, although a complete manifestation of the invention providing there is compliance with fiscal financial projections, however are not enough for the investor to know whether the share structure, and specifically the preferred shares, comply with the fiscal financial projections 40. The fiscal financial projections 40 must be reviewed and they are not generally public documents for privately held corporations starting new ventures. That simple determination can be made however on review by the investor of the fiscal financial projections, or another document which incorporates those fiscal financial projections within them, such as an offering memorandum or a prospectus, which are required by most jurisdictions to be provided by corporations to at least some potential investors before investment can be made.

By offering memorandum or prospectus, it is meant a completely articulated business plan incorporating all known relevant circumstances, including, but not limited to, the formal fiscal financial statements, the risk factors, the markets, and the expenses.

As soon as the fiscal financial projections and articles of incorporation, as described above and as explained in the claims, exist at the same time to be consistent with each other, however, the invention in its preferred embodiment has been manifested in regard to a single corporation.

So it is that the articles of incorporation 72, by being in accordance with the fiscal financial projections in the share structure impose an infrastructure of fairness, transparency and control that cannot be changed without amendment, nor can they be over-ridden by the originator, or any party, unilaterally. There is now a reduced possibility of tense confrontation between the investor and the originator providing the originator and the investor use the infrastructure as it was meant to be used, with the investors only entering into the company through the preferred shares, and the originator maintaining ownership of the common shares. All three of the originator, the investor and the company each get what they want. The originator can maintain control of the corporation and his equity is safe in the first class of common shares; the investor is assured of his return at whatever his sought-after rate of return may be by dictum of the articles of incorporation regarding preferred shares and the corporation, ie the company, receives stability of management, the ability to receive financing from investors the ability to interact with the market.

This invention also mitigates the possibility of the occurrence of Ponzi or, now often called Madoff, schemes, for raising investment money from investors. A Ponzi scheme (aka Madoff scheme) is where an originator, usually an investment broker, but not always, takes investment money from a number of investors and uses money received from later investors to issue dividends to earlier investors all the while representing that the dividends are issued from profits of the venture. In the present case, with a new venture, the fiscal financial projections create concrete milestones, and there is too much monitoring and involvement with investors to permit that to occur. Re-iterating the obstacles that face many corporations with new ventures, in the case of a corporation that adopts this invention, everyone is protected by the transparency, fairness and balanced control.

Therefore, not only are the values of the shares more easily valued so too are the actual acts of the corporation exist.

The infrastructure, the necessary planning and the flattened level playing field as between the parties having been codified by the parameters in the articles, there is permitted, if desired by the originator, an advantage not easily achievable in respect of money raising activities for corporations involved in new ventures: money can be raised in smaller amounts from a greater number of investors than would otherwise be the case. With the transparency regarding return, and the level of research, a smaller investor is more easily able to grasp the nature of the venture and assess the risk than s/he would otherwise be able to do. This invention permits the owner to bring in money on an as-needed basis, preferably in small amounts from different investors. Similar to the popular idea of retailers to have inventory available on an as-need basis, a procedure popularly referred to as “just in time inventory”, a similar process may be used for investment funds making them “investment on demand”. This ensures that, with proper stewardship of the corporation, there is the possibility that there can be a more continuous inflow, rather than receiving the funds in jumps and starts which is the usual scenario with large sums being invested. Several advantages result. It is easier to get smaller amounts from several knowledgeable investors as opposed to a large amount from any one single investor, whether he be knowledgeable or not. Moreover, it will be apparent that the value, and hence the price that the originator can get for preferred shares will increase as each milestone in the fiscal financial projections is met, meaning that if investment is brought in by smaller amounts timed over the middle 12 of the venture 8, the increase in the value will be realized. The increase also creates incentive regarding performance. As well, this mechanism ensures that the originator running the business will be prudent in utilizing the corporation's resources, and consider alternative strategies over a longer period of time, rather than only at the time when investment money is being sought, and the larger investor is at the table. As well, the corporation will, by bringing in more investors, enlarge its pool of advisors and experts, the investors being a ready pool of talent which can be culled for developing the business. For instance, they can be used for focus groups and their comments considered in the commercial options which might be pursued for the product or service.

The other aspect of the present share structure, which forms part of the present invention, is of course, that the shares can be traded for services as well. A contractor is more likely to exchange his services or products for shares where the return and conduct of the principals is codified in the articles and carefully considered in the financials than having to bet on a gut instinct where everything is undefined and open to interpretation and discretion.

It will be apparent that variations are possible to suit the circumstances desired without deviating from the scope of the invention. For instance, an offering memorandum or prospectus can be prepared to provide a means of presenting not only the fiscal financial projections but the other factors incorporated into the fiscal financial projections so that they can be readily discerned by any potential investor. The more often that fiscal financial projections are amended as the venture progresses, the more informed and improved the transparency will be. Agreements can be entered into with shareholders or potential investors regarding commitments of the originator either not to sell his common stock, to provide a right of first refusal to the preferred shareholders if the sale of common stock is contemplated, if there is a right of first refusal perhaps terminate that right of first refusal upon either the non-pertinent stage being met (when the preferred dividends begin to become issuable) or after the condition of discontinuance (when the preferred dividends no longer create a liability); define the threshold of revenues of sales precisely enough so that no issuance of preferred dividend occurs until after the non-pertinent stage has been reached; create a specific fund that collects the preferred dividends as they become issuable from which the dividends are then to be issued; solidifying the balance and the investors' position by requiring in the articles that no debt be incurred by the corporation while the conditions of discontinuance have not yet occurred; using the internet as a means of reporting and exchanging information regarding the corporation and the preferred shares and effecting transfer of shares over the internet; developing an interactive procedure to be effected over the internet for the preparation of the fiscal financial projections or the articles of incorporation in accordance with this invention; and providing a preference within the articles to preferred shareholders over common shareholders attaching to the assets of the corporation in the case of insolvency or acts of bankruptcy. These variations all flow from the initial embodiment, adding to and taking advantage of the advances provided. Their inclusion, although utilizing the invention synergistically, is within the scope of the invention, but their exclusion does not avoid the scope of the invention.

Many variations are possible.

But having set out this invention, its benefit and manifestation does not end with only the single corporation 32 founded and run by the originator 8. This invention has also created a standard whereby an originator can structure a company and more easily compare his company to the performance of other companies 80 similarly structured. Similarly, investors can more easily compare companies adopting the standard of this invention as well. The scope of the scope of the invention expands from a single corporation to a group of corporations, each formed in accordance with this invention.

So it is that further advantages exist when several of these corporations are grouped together in an exchange 82 for trading shares. If several of the corporations belonging to this exchange 82 have preferred shares 56 created to finance new ventures 8 in accordance with this invention are together in a single forum, investors 30 familiar with how one of the companies is structured will more readily understand how another of the companies is structured. Companies are more easily compared if similarly structured, and if the structure creates a fairness, transparency and balance of control, the similar structure in creating advantages for one of the companies extends to all of the companies in the group, making the group as a whole a safer domain for investment. Such would be the case if member corporations 80 of an exchange 82 would be created in accordance with fiscal financial projections 40 and the return based on the share structure defined in the articles of incorporations with both with a readily apparent portion of revenue on sales issuable to shareholders only after a threshold of revenues on sales has been achieved, and the issuance of the dividend having a continuation of discontinuance.

The advantages of providing an exchange are that the exchange can be managed to ensure compliance with rigorous standards of accounting for the preparation of fiscal financials and that there can be a body to advise the companies how to prepare the fiscal financials. Furthermore, shareholders owning preferred shares of one corporation can sell or acquire preferred shares directly with other shareholders. The shares now have some degree of liquidity and transferability. It has often been a detriment to the raising of investment money that shareholders cannot sell easily sell their shares in a private company. However, further to the shares being more easily evaluated because of the share structure, there is now a mechanism whereby the shares can be acquired or shed. There is a new exit strategy.

So it is that there is provided of a forum for trading shares of privately-held corporations engaged in new ventures. The forum is an exchange comprising several privately held corporations 80. The exchange 82 is operated to provide an infrastructure to facilitate access to information regarding the share structure, the nature of the venture and the fiscal financial projections of the member corporations. It is also operated to permit contact between the shareholders so that they can trade shares with each other. The member corporations are privately-held and the ventures in which they are involved are new ventures, which quite distinguishes this type of exchange 82 from the exchanges presently available for trading. Member corporations shall have a share structure with both common shares and preferred shares. As is usual, the preferred shares will have preferred dividends wherein the privately-held corporations can issue preferred shares with preferred dividends. As is not usual, the preferred dividends being based on a pre-defined portion of the revenues on sales for a venture, while defined as being issuable after a pre-defined threshold of revenues on sales for the venture has been achieved. For the reasons outlined above, the preferred dividend shall be defined as having a condition of discontinuance.

The exchange will also provide a means of contact with other shareholders. As well, the exchange can advantageously provide the services of explaining the business model and the structure of the shares to potential investors to that potential investors can review the information and make an informed decision. Ideally, the exchange would exist over the internet to increase the degree of access to interested parties.

The exchange is advantageous as well for the corporation because it provides ready access for the member corporations to investors without having to expend energy in presenting and explaining the share structure. The shareholders, already existing in corporations that are structured in accordance with this invention, are readily familiar with how to evaluate the corporations. If an investor wishes to acquire shares directly from the corporation, s/he can use the information and contact the corporation directly outside of the exchange while using the exchange.

The corporations participating will, of course, have to issue offering memorandums, in accordance with the laws of the jurisdiction within which they are incorporated. Those offering memorandums will incorporate all essential aspects of the invention including the financial projections, share structure and assessment of when and how the non-pertinent stage shall be reached.

Prior to this invention, when companies were incorporated, there were no parameters of this nature created, and therefore missing within the articles, the business plan and the financials was the necessary balance of transparency, fairness and control.

With this invention, either singly used for only one corporation, or used for several corporations as a group, either as a division, or as an exchange for investors, it can now be an act of the past where it will be as difficult to evaluate a corporation.

Combining these attributes at the early stage of the business, there is established a balance that can be maintained for the venture throughout the initial stages until self-sufficiency is reached.

This invention shall change the way that the investor, the entrepreneur and the company does business, ensuring that everyone comes in on fair terms and treats the other party with fairness and transparency. It defines the rules of engagement at the very beginning, when judgment is calmest and at its best, not at the point of crisis, which is the point when errors and misjudgment are most likely to occur. As such, it will represent a true advancement in how business is conducted and a new level of transparency, security and fairness for all participants.

It is not intended that this specification be read in a limiting manner, but rather that the invention be understood as a whole from the embodiments described herein. The embodiments described in the specification are preferred embodiments, and changes incorporated into the preferred embodiments without deviating from the scope of the invention will be readily apparent to those skilled in the art. The invention is as claimed in the appended claims.

As can be understood from the above description and from the accompanying drawings, the present invention provides an invention so that the conduct of any of the main four participants (originator, investor, company, and market) is refrained from contributing to the mishandling of many of the common problems that start-up ventures face, and are guided to deal with each other in a manner to that end, the main problems having to do with the possibility of the ventures failing due to product-market miscalculation; imprudent financing; off-kilter originator-investor-market relationships and interactions; improper task delegation; and inadequate administrative (accounting and legal) support; provides for both a decent return to the investor and, as well, that provides the originator with the means to maintain control and ownership of the business while himself receiving fair remuneration; provides an invention for a business that permits the starting up and the efficacious running of the venture with guidelines and parameters enforcing fairness as between the originator, the investor, the market and the company. Whoever works for the company, whoever invests in the company and whoever runs the company can only work within those parameters. That being so, with these parameters preventing many of the major mistakes known and acknowledged to be detrimental to the starting of a venture, the company and business are better able to flourish; provides a process that when adopted by a company will give assurances, to the investor, of a standard of transparency, fairness and control balance that results from the application of the process; provides an invention that when adopted by a group of companies, this group of companies will have shares which can be relatively valued and traded as between the shareholders of the different companies within the group; provides a method of doing business, which can be adopted by companies within a trading exchange, so that these companies can be recognized by investors and valued accordingly; creates an exchange which includes companies formed and operating in accordance with this invention that would permit the shareholders of the various companies to trade amongst themselves; creates a quality control overseer organization to which companies adopting this invention can belong so to use a confirmation of membership to this overseer organization as an indicator to investors and potential investors that this invention is being utilized by a company; provide an exchange which includes companies formed and operating in accordance with this invention to facilitate access of the originator and company to the investor, and provides a means whereby the business model is explained to the investor in a standardized and safe manner, all of which features are unknown in the prior art.

It is not intended that this specification be read in a limiting manner, but rather that the invention be understood as a whole from the embodiments described herein. The embodiments described in the specification are preferred embodiments, and changes incorporated into the preferred embodiments without deviating from the scope of the invention will be readily apparent to those skilled in the art. The invention is as claimed in the appended claims.

I claim:

1. A method for the carrying out of a new venture comprising the steps of:
a) the creation of a share structure, which defines common shares, and preferred shares, wherein the preferred shares have a preferred dividend issuable to the owners of preferred shares in a manner consistent with the attaining of a stage where revenues on sales in the venture are sufficient to render the further sale of preferred shares not pertinent to the financing of the venture, the stage being a non-pertinent stage, the issuance of the preferred dividend being defined as having a condition of discontinuance;
b) the preferred shares only providing for the issuance of a preferred dividend upon achieving a defined threshold of revenue on sales for the venture by the corporation;
c) the creation of financial projections predicting the occurrence of the non-pertinent stage.

2. A method as claimed in claim 1, wherein there is prepared an offering memorandum incorporating the financial projections and share structure.

3. A method as claimed in claim 1, wherein there is prepared articles of incorporation which define the share structure.

4. A method as claimed in claim 1, wherein there is prepared fiscal financial statements integrating investor activity regarding the share structure as the venture proceeds.

5. A method as claimed in claim 1, wherein an agreement is entered into with a non-shareholder for the transfer of the shares of the second class.

6. A method as claimed in claim 1, wherein the second class of shares do not provide for the paying out of any preferred dividend until after the non-pertinent stage has been reached.

7. A method as claimed in claim 1, wherein there is created a specific fund into which a portion of revenues on sales are set aside specifically to pay the preferred dividends.

8. A method as claimed in claim 1, wherein there is created a specific fund into which a portion of revenues on sales are set aside specifically to pay the preferred dividends, the portion of revenues on sales being defined in the articles of incorporation.

9. A method as claimed in claim 1, wherein any transfer of any common shares is restricted by a right of first refusal granted to owners of preferred shares.

10. A method as claimed in claim 1, wherein any transfer of any common shares is restricted by a right of first refusal granted to owners of preferred shares, said right of first refusal only existing when there survives the possibility of a preferred dividend issuance.

11. A method as claimed in claim 1, wherein there is provided a restriction on how debt may be incurred in respect of the corporation while there survives the possibility of a preferred dividend payout.

12. A method as claimed in claim 1, wherein there is provided a right to buy and sell shares by the owners of shares in the corporation with owners of shares in other corporations structured similarly.

13. A method as claimed in claim 1, wherein there is provided a requirement of auditing and reporting to the owners of shares using the internet as a means of reporting.

14. A method as claimed in claim 1, wherein there is also provided a third class of shares with a second preferred dividend payable to the holders of the third class of shares in respect of a different venture.

15. A method as claimed in claim 1, wherein a preferred share is defined as being convertible to a common share on demand of the owner of the preferred shares.

16. A method as claimed in claim 1, wherein preferred shares are defined as having converted to common shares upon all obligations of paying out any preferred dividend having terminated.

17. A method as claimed in claim 1, wherein the owners of preferred shares are given the right to buy and sell preferred shares over the internet with owners of shares in other corporations similarly structured.

18. A method as claimed in claim 1, wherein the owners of preferred shares are given the right to buy and sell preferred shares over the internet with other owners of preferred shares in the same corporation.

19. A method of doing business, wherein a corporation is organized under articles of incorporation to carry out a new venture comprising implementing an articles of incorporation into the running of a business wherein:
a) the articles of incorporation shall define a share structure comprising common shares, and preferred shares, wherein the preferred shares have a preferred dividend issuable only to the owners of preferred shares in a manner that will not prevent the attaining of a stage where revenues on sales in the venture are sufficient to render the further sale of preferred shares not pertinent to the financing of the venture, this stage being a non-pertinent stage, the issuance of the preferred dividend being defined as having a condition of discontinuance;
b) the articles of incorporation define the preferred shares as not providing for the issuance of any preferred dividend until after a minimum threshold of revenue on sales for the venture has been received by the corporation.

20. A method as claimed in claim 19, wherein the articles of incorporation require the preparation of an offering memorandum incorporating fiscal financial projections and share structure.

21. A method as claimed in claim 19, wherein the articles of incorporation are prepared to define the preferred shares of the second class of shares as non-voting.

22. A method as claimed in claim 19, wherein the articles of incorporation define the preferred shares so that there is no paying out of any preferred dividend until after the non-pertinent stage has occurred.

23. A method as claimed in claim 19, wherein the articles of incorporation permit the preferred shares to be freely transferable to non-shareholders and wherein the articles of incorporation provide restrictions, which become inactive after the non-pertinent stage has occurred, on the transfer of common shares.

24. A method as claimed in claim 19, wherein the articles of incorporation do not provide for the paying out of any preferred dividend relating to a venture until after the non-pertinent stage has been reached for the venture.

25. A method as claimed in claim 19, wherein the articles of incorporation define a specific fund into which a portion of revenues on sales are set aside from other revenues on sales to pay the preferred dividends.

26. A method as claimed in claim 19, wherein the articles of incorporation restrict any transfer of common shares by a right of first refusal granted to owners of preferred shares.

27. A method as claimed in claim 19, wherein the articles of incorporation restrict any transfer of common shares by a right of first refusal granted to owners of preferred shares, said right of first refusal being defined to exist only when there survives the possibility of a preferred dividend payout in respect of the preferred shares.

28. A method as claimed in claim 19, wherein the articles of incorporation are generated over the internet.

29. A method as claimed in claim 19, wherein the articles of incorporation provide restrictions on how debt may be incurred in respect of the corporation while there survives the possibility of a preferred dividend issuance in respect of the preferred shares.

30. A method as claimed in claim 19, wherein the articles of incorporation provide for the right to buy and sell shares by the owners of shares in the corporation with owners of shares in other corporations structured similarly.

31. A method as claimed in claim 19, wherein the articles of incorporation define a requirement of auditing and reporting to the owners of shares using the internet as a means of reporting.

32. A method as claimed in claim 19, wherein the articles of incorporation define a second preferred shares having a second preferred dividend payable to the holders of the second preferred shares in respect of a venture that is different than the venture relating to the revenue on sales contributing the payment of the preferred dividend of the preferred shares for the venture as aforesaid claimed.

33. A method as claimed in claim 19, wherein the articles of incorporation provide that the preferred shares are convertible to common shares on demand of the owner of the preferred shares of the second class.

34. A method as claimed in claim 19, wherein the articles of incorporation provide that the preferred shares are convertible to common shares upon all obligations of paying out any preferred dividend having terminated for the preferred shares.

35. A method as claimed in claim 19, wherein the articles of incorporation provide for the owners of preferred shares to be given the right to buy and sell preferred shares over the internet with owners of shares in other companies similarly structured.

36. A method for organizing a corporation involved in a new venture, the steps of:
a) preparing articles of incorporation in accordance with financial projections identifying the stage wherein the sale of preferred shares become non-pertinent to financing the venture wherein the articles of incorporation are drafted
I) to define the share structure to provide for the issuance of both common shares and preferred shares, wherein the preferred shares have a preferred dividend issuable to the owners of preferred shares only after a minimum threshold of revenue on sales for the venture has been received by the corporation; and
ii) to define the issuance of the preferred dividend as having a condition of discontinuance.

37. The method as claimed in claim 36, wherein the articles of incorporation are prepared to expressly require the preparation of an offering memorandum for potential investors incorporating fiscal financial projections and share structure.

38. The method as claimed in claim 36, wherein the articles of incorporation are prepared to define the preferred shares to prevent the paying out of any preferred dividend until after the non-pertinent stage has been reached.

39. The method as claimed in claim 36, wherein the articles of incorporation are prepared to define the preferred shares as non-voting.

40. The method as claimed in claim 36, wherein the articles of incorporation are prepared to require the creation by the corporation of a specific fund into which a portion of revenues on sales are to be set aside to pay the preferred dividends owing in respect of preferred shares.

41. The method as claimed in claim 36, wherein the articles of incorporation are prepared to restrict any transfer of the first class of shares by way of a right of first refusal granted to owners of the preferred shares, said right of first refusal being defined to exist when there survives the possibility of a preferred dividend payout in respect of the preferred shares.

42. The method as claimed in claim 36, wherein the articles of incorporation are prepared to provide a restriction on how debt may be incurred in respect of the corporation while there survives the possibility of a preferred dividend payout in respect of the preferred shares.

43. The method as claimed in claim 36, wherein the articles of incorporation are prepared to provide for the right to buy and sell preferred shares by the owners of preferred shares with owners of shares in other companies similarly structured.

44. The method as claimed in claim 36, wherein the articles of incorporation are prepared to define a requirement of regular auditing and reporting to the owners of the preferred shares using the internet as a means of reporting.

45. The method as claimed in claim 36, wherein the articles of incorporation are prepared to define a third class of shares with second preferred shares having a second preferred dividend payable to the holders of the second preferred shares in respect of a venture that is different than the venture relating to the revenue on sales contributing the payment of the preferred dividend of the preferred shares as aforeclaimed in claim 32.

46. The method as claimed in claim 36, wherein the articles of incorporation are prepared to provide that the preferred shares are convertible to common shares of the first class of common shares on demand of the owner of the preferred shares.

47. For a company, the method as claimed in claim 36, wherein the articles of incorporation are prepared to provide that the preferred shares are to be converted by the corporation to common shares upon all obligations of paying out any preferred dividend having terminated.

48. The method as claimed in claim 36, wherein the articles of incorporation are prepared to provide the owners of preferred shares the right to buy and sell the preferred shares with owners of shares in other companies similarly structured using the internet as a means of exchange.

49. A method of doing business, wherein services of a forum for trading shares of privately-held corporations are provided, comprising the steps of:
operating an exchange, the exchange forum comprising several privately-held corporations each having common shares and preferred shares, the preferred shares having a preferred dividend wherein the privately-held corporations can issue preferred shares with preferred dividends, the preferred dividends being based on a pre-defined portion of the revenues on sales for a venture, the preferred dividends being defined as being issuable after a pre-defined threshold of revenues on sales for the venture has been achieved and also being defined as having a condition of discontinuance;
the exchange being operated to permit the preferred shares to be traded, bought and sold amongst different owners of shares of member corporations on the exchange.

50. A method of doing business as claimed in claim 49, wherein at least some of the member corporations issue into a trust fund preferred dividends owing to owners of preferred shares, wherein the trustee has undertaken to pay to the owner of the preferred share proceeds from the trust fund payable in respect of any preferred dividend.

51. A method of doing business as claimed in claim 49, wherein the owing and paying of preferred dividends is monitored for shareholders.

52. A method of doing business as claimed in claim 49, wherein the process of preferred dividend payment in respect of the preferred shares is insured.

53. A method of doing business as claimed in claim 49, wherein the forum is managed to provide for the transfer, buying and selling of shares of preferred shares amongst shareholders over the internet.

54. A method of doing business as claimed in claim 49, wherein:
exchange requires that the member corporations must include within the articles of incorporation a providing for the issuing of common shares and preferred shares, wherein the preferred shares have a preferred dividend payable only to the owners of preferred shares based on a pre-defined portion of revenues on sales for a venture of the member corporation, the preferred dividend being defined as being payable after a pre-defined minimum of revenues on sales has been achieved and as having a condition of discontinuance.

55. A method of doing business as claimed in claim 49, wherein: the exchange shall cause the member corporations to generate fiscal financial projections for the revenue on sales of the company which cover at least the period from the date of incorporation until the projected date when the company's revenues from sales will begin to continue to be greater than its expenses to the extent that the corporation attains a self-sustainability stage at which the corporation is no longer in need of requiring further investment monies from investors to operate in respect of the venture, and need no longer issue preferred shares; the exchange shall require the member corporations to obtain approval of the exchange for the fiscal financial projections before the member company may have shares of the second class of shares traded through the forum.

56. A method of doing a business as claimed in claim 49, wherein the exchange shall require that member corporations not pay out any preferred dividend for the preferred shares until after the self-sustainability stage for the venture, as would be determined by the fiscal financial projections, has been reached.

57. A method of doing a business as claimed in claim 49, wherein the exchange shall require the require the preparation of an offering memorandum incorporating the fiscal financial projections and share structure of the member corporation, and that the offering memorandum be approved by the exchange before shares of the second class of shares of the member corporation are traded through the forum.

58. A method of doing a business as claimed in claim 49, wherein the articles of incorporation of at least some of the member corporations define preferred shares of the second class of shares so that there is no paying out of any preferred dividend for the preferred shares the stage where revenues on sales in the venture are sufficient to render the further sale of preferred shares not pertinent to the financing of the venture.

59. A method of doing a business as claimed in claim 49, wherein the exchange shall require that member corporations involved in trading preferred shares through the forum are organized under articles of incorporation defining the preferred shares to restrict any issuing of any preferred dividend until after a minimum amount of revenue on sales has been received by the corporation.

60. A method of doing business as claimed in claim 49, wherein the exchange shall require that each member corporation shall set aside in a fund the preferred dividends payable to owners of preferred shares before making payment of the preferred dividend.

61. A method of doing business as claimed in claim 49, wherein the exchange shall require that member corporations involved in trading preferred shares through the forum are organized under articles of incorporation restricting any transfer of the common shares by a right of first refusal granted to owners of the preferred shares, said right of first refusal existing when there survives the possibility of a preferred dividend payout in respect of the preferred shares.

62. A method of doing business as claimed in claim 49, wherein the exchange shall require that member corporations involved in trading preferred shares through the forum be organized under articles of incorporation creating a restriction on how debt may be incurred in respect of the corporation while there survives the possibility of a preferred dividend payout.

63. A method of doing a business as claimed in claim 49, wherein the exchange shall require reporting of audited statements and the issuance of any offering memorandums to the owners of the preferred shares using the internet as a means of reporting.

64. A method for the providing of goods or services to a market comprising the steps of:
a) preparing fiscal financial projections for the venture wherein the corporation for the venture shall have preferred shares apart from common shares to permit the corporation to finance the venture;
b) preparing the fiscal financial projections to predict the stage where revenues on sales in the venture are sufficient to render the further sale of preferred shares not pertinent to the financing of the venture;
c) preparing the fiscal financial projections in contemplation that preferred dividends for the preferred shares shall have a condition of discontinuance;
d) preparing the fiscal financial projections in contemplation that the preferred shares shall not provide for the issuance of any preferred dividend until after a defined threshold of revenue on sales has been received by the corporation for the venture;
e) preparing of the financial projections to provide a threshold of revenue on sales to be inserted into the articles of incorporation to define the conditions for issuance of the preferred dividend.

65. A method for the carrying out of a business venture as claimed in 64, wherein the financial projections are generated on a computer using an interactive computer program.

66. A method of developing financial projections as claimed in 64, wherein the financial projections are generated on a computer using an interactive computer program over the internet.
